(19) United States
(12) Patent Application Publication
(10) Pub. No.: US 2007/0098362 A1
(43) Pub. Date: May 3, 2007

(54) Content item recorder and method of recording therefor

(76) Inventor: Pankaj Sharma, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,374

(22) PCT Filed: May 13, 2004
(86) PCT No.: PCT/IB04/50674

§ 371 Date: Dec. 28, 2006

(30) Foreign Application Priority Data
May 20, 2003 (EP) 03101423.6

(51) Int. Cl. H04N 5/91

(52) U.S. Cl. 386/94

(57) ABSTRACT

The invention relates to a content item recorder such as a DVD recorder. The recorder comprises a user input (111) for receiving protection information from an end user. A section processor (113) divides the content item into sections in response to the protection information, and an access characteristic processor (115) determines an access characteristic for each section. The content item and access information is stored on a recordable medium (119) by a recording processor (117). For example, a restricted access playlist comprising all sections is stored together with an unrestricted access playlist not comprising protected sections. At playback, an access permission level is determined by an access level processor (125) from an access user input (123). A presentation signal is generated by a presentation processor (127) in accordance with the access permission level. If an unlimited access permission level is set, the restricted access playlist is used, and otherwise the unrestricted access playlist is used. Accordingly, flexible parental control is provided.

The invention relates to a content item recorder and method of recording therefor and in particular to a content item recording system providing flexible access control.

Over the last decades, private recording and playback of audiovisual signals has become widespread and is now a common part of everyday life in many cultures. For example, the advent of video cassette recorders and video cameras has provided the means for consumers to record TV programmes or to create original video footage.

In recent years, digital video equipment has become more prevalent and has reduced significantly in price. Accordingly, the sale of digital video recording equipment in the consumer market is currently increasing at a high rate. For example, digital video cameras now outsell analogue video cameras.

The existence of digital video standards, such as MPEG 2, has resulted in a wide variety of interoperable video equipment and media for distribution of audiovisual content. For example, the Digital Versatile Disc (DVD) is rapidly replacing video cassettes as the most popular format for distribution of video content for rental or purchase. In addition to higher quality, digital video standards allows for increasing flexibility and possibilities in the processing and storage of audiovisual content For example, pre-recorded DVDs allows for instant selection of scenes, selection of different language options or different subtitles etc. Also, the digital video formats have significantly facilitated video editing and allowed for cheap video editing means suitable for the consumer market. In particular, the increased popularity of digital video cameras and home computers of increasing capability has resulted in the means for editing video footage being increasingly accessible to the consumer. In addition, many consumer electronic devices are becoming available which have some built-in video editing features.

An example of consumer equipment for storage of audiovisual signals is a DVD (Digital Versatile Disc) recorder, which has recently been introduced to the consumer market. A DVD recorder allows a user to record one or more audiovisual signals on a recordable DVD medium. Typical, DVD recorders comprise means for recording, editing and organising the audiovisual signals being stored. For example, a plurality of items may be recorded on a DVD. Thus a recorded DVD may for example comprise received TV programmes or films as well as video footage from a digital camera. Thus, a user may mix different content from different sources. Typically, several hours of audiovisual signals may be recorded on a single DVD medium, and therefore many DVDs will comprise a plurality of different items.

Another example of consumer equipment for storage of audiovisual signals is Personal Video Recorders (PVRs), which typically record audiovisual signals on a permanent hard disk rather than on a removable recordable medium. PVRs typically comprise hard disks sufficient to record several tens of hours of video footage thereby allowing a high number of e.g. TV programmes to be stored on the hard disk.

A common concern of many consumers of video recording equipment is how to control access to the recorded content such that unsuitable material is not presented to viewers for which it is not appropriate. Specifically, many programmes may contain scenes containing violence, horror or sex which is considered not to be appropriate for e.g. children.

Thus many consumers prefer that parental control of access to the recorded content is available.

Accordingly, consumer video recording equipment typically includes some means for restricting access to the contents of the recordable medium. Specifically, DVD recorders are known to have access protection consisting in a recorder lock or disc lock function. In accordance with the recorder lock approach, a recorder pin code must be entered for the recorder to operate. This allows the use of the recorder to be restricted to individuals knowing the access pin code. In accordance with the disc lock approach, a disc pin code must be entered for the recorder to access the recorded content on the locked disc. This allows the use of the disc to be restricted to individuals knowing the access pin code although other unprotected discs may be accessed by a user not knowing the access pin code.

However, both of these approaches tend to be inflexible and not provide all the access control functions and flexibility desired by a user. Specifically, the recorder lock function prevents the recorder from being used by any user not having the access pin code whether for playback of suitable content or not. Similarly, the disc lock function prevents that suitable content of the disc is played back to a user not knowing the access pin code. For example, children may not have knowledge of the access pin code and may accordingly be prevented from using the recorder to play suitable discs or may be prevented from accessing suitable content items stored on a locked disc. Thus children need their parents to unlock the recorder or disc even in order to access content suitable for children. Furthermore, different user environments are likely to have different requirements for access control, and the known access controls prevents this from being adapted to the specific preferences of the current user group. For example, different families may have different opinions of what is suitable for the children and the suitability may depend on the individual child (for example on the age of the child).

Hence, a content item recorder having improved access control would be advantageous and in particular a content item recorder allowing for increased flexibility of the access control would be advantageous. Specifically, it would be advantageous to have an access control allowing for a flexible adjustment to a given user environment and which is not overly restrictive in preventing access to suitable content.

Accordingly, the Invention preferably seeks to mitigate, alleviate or eliminate one or more of the above mentioned disadvantages singly or in any combination.

According to a first aspect of the invention, there is provided a content item recorder comprising: means for receiving a content item for recording; a user input for receiving protection information from an end user; means for dividing the content item into a plurality of sections in response to the protection information; means for determining an access characteristic for each of the plurality of sections in response to the protection information; means for storing the content item and access information comprising the access characteristic for each of the plurality of sections on a recordable medium.

The invention thus allows for a content item recorder providing very flexible access control. The invention allows for an end user to select different sections of content items and associate an access characteristic to each. Thereby, the end user may customise the access control to a content item to his specific requirements and desires. The user may furthermore select different access characteristics for different sections. For example, two level of access characteristics may be used and each section may be assigned one of the two access level characteristics. One level may correspond to the content being available for everybody (e.g. including children) whereas another level may correspond to content appropriate only for a subgroup (e.g. adults). As an example a regular playlist and an adults only playlist may be stored on the recordable medium. The user is not limited to provide access control related to the entire content item recorder, an entire recordable medium or even an entire content item. Rather, individual sections of the content item may have different access characteristics thereby allowing different versions of the content item being accessed in response to the different access characteristics. A very flexible access control with a very high degree of user customisation is thus enabled. For example, parental control of content items on a recordable medium is enabled wherein parents may specifically select unsuitable sections which are given an access characteristic preventing these sections from being accessed by children. The recordable medium may for example be a removable medium. The sections may be parts of the content item chosen by the end user to be characterised as protected or unprotected parts. The sections may be determined or fixed by a standard of the content item and the access characteristic may be set by the end user as protected or unprotected for each of the fixed sections.

According to a feature of the invention, the means for determining an access characteristic further comprises: means for determining at least a first protected section of the plurality of sections in response to the protection information; means for generating a restricted access playback sequence indication comprising the first protected section; means for generating an unrestricted access playback sequence indication not comprising the first protected section; and means for including the restricted and unrestricted access playback sequences in the access information.

For example, a restricted access and an unrestricted access playlist may be recorded on the recordable medium wherein the restricted access playlist comprises a protected section whereas the unrestricted access playlist skips this section. The unrestricted access playlist may thus correspond to the original content item but with unsuitable sections (such as scenes in a video sequence) being skipped. A player using the restricted access playlist may thus show the full content item whereas a playback using the unrestricted access playlist will skip one or more sections that have been marked by the end user. Thus the same content item may be presented in different versions. For the unrestricted access playlist there is preferably no restriction in the access requirements, and it is thus preferably available to all users including for example children. For the restricted access playlist there is preferably a restriction in the access to a subgroup of users such as for example only to adults. The feature allows for the different versions of the content item being determined and generated during the recording or editing phase. Additionally or alternatively, the feature allows for a very simple and low complexity playback of the different versions of the content item on the recordable medium.

According to another feature of the invention, the restricted access playback sequence indication or the unrestricted access playback sequence indication comprises an ordered playback sequence of at least some of the plurality of sections. This allows for a simple and low complexity playback of the content item from the recordable medium.

According to another feature of the invention, the restricted access playback sequence indication comprises an ordered playback sequence of the plurality of sections and the unrestricted access playback sequence indication comprises an ordered playback sequence of a subset of the plurality of sections. This allows for a low complexity and easy to implement way of generating different versions of a content item and specifically allows for unsuitable sections to be determined by an end user and omitted from an unrestricted access playback sequence.

According to another feature of the invention, the content item recorder further comprises playback means for generating a presentation signal from the content item stored on the recordable medium, the playback means comprising means for receiving an access input from a playback user; means for setting an access permission level in response to the access input; means for retrieving the content item and the access information from the recordable medium; and means for generating a presentation signal for the content item in response to the access permission level and the access information.

This allows for a low complexity and highly flexible access control when playing back a content item on the recordable medium. The access input is suitable for identifying a user and an appropriate access may be provided in accordance with the access characteristic determined in response to the end users preference and stored on the recordable medium. For example, if a parental code is entered, full access may be provided whereas if a parental code is not entered only access to parts of the content item characterised as suitable for children by the end user when recording the content item is provided.

According to another feature of the invention, the means for generating a presentation signal is operable to generate the presentation signal only from sections of the plurality of sections for which the access characteristic indicates that access is permitted for the access permission level. This allows for a very flexible access control that allows access to different version or sections of the content item depending on the access permission level. For example, for a given access permission level some sections of the content item may be skipped whereas these are included for other access permission levels,

According to another feature of the invention, the access information comprises a restricted access playback sequence indication comprising a first protected section and an unrestricted access playback sequence indication not comprising the first protected section and the means for generating a presentation signal is operable to generate the presentation signal from the restricted access playback sequence indication if the access permission level corresponds to an unlimited access permission level and for generating the presentation signal for the content item in response to the unrestricted access playback sequence indication if the access permission level corresponds to a limited access permission level. This enables low complexity playback of different versions of a content item in response to access preferences of a user (e.g. a parent) in response to an access code entry of a viewer (e.g. a child). Hence, a very flexible and low complexity access control is provided which enables access control to a content item to be customised to the individual user.

According to another feature of the invention, the means for recording is operable to record a plurality of content items and a protection indication for each of the plurality of content items; wherein the protection indication for a content item indicates if the content item is protected. This allows for a plurality of content items being stored on the same recordable medium while enabling individual and flexible access control for each content item independent of the access restrictions of other content items. Specifically, different versions of content items may be played back depending on an access permission level of the viewer. Furthermore, access may be denied to some content items without hindering access to other content items. Hence, a hierarchical access control is enabled for a single recordable medium comprising a plurality of content items.

According to another feature of the invention, the content item recorder further comprises means for recording on the recordable medium an access code associated with the access information. This may allow for increased access control with additional flexibility and may specifically enable access to be under the control of the end user of the content item recorder. Accordingly, it allows for an end user to maintain control over who is provided with an access code allowing the content item to be accessed.

According to another feature of the invention, the content item recorder further comprises means for receiving the content item from a content provider. The invention allows for an end user to customise access control and access permission to a content item from a content provider to be customised to his specific preferences and requirements.

According to another feature of the invention, the content provider is a broadcast content provider. The invention enables an end user receiving a point to multipoint broadcast to record the broadcast thereby providing access control in accordance with his specific preferences and requirements.

According to another feature of the invention, the recordable medium is a recordable Digital Video Disc (DVD). Preferably, the, the recordable DVD is in accordance with the DVD +ReWritable video format specifications. Thus, the invention preferably allows for a flexible, customisable and/or low complexity access control to be provided for a DVD recorder.

According to another feature of the invention, the content item is an audiovisual content item. The audiovisual signal may be a video only or audio only signal but preferably comprises real time video and audio sequences. The content item may for example be a recorded video sequence from a video programme, a TV programme, a film, a song, a live event or a radio programme.

According to a second aspect of the invention, there is provided a content item player for generating a presentation signal from a recordable medium comprising a content item dividing into a plurality of sections and access information comprising an access characteristic for each of the plurality of sections; the playback means comprising: means for receiving an access input from a playback user; means for setting an access permission level in response to the access input; means for retrieving the content item and the access information from the recordable medium; and means for generating a presentation signal for the content item in response to the access permission level and the access information. A content item player is thus provided allowing low complexity, flexible and/or customisable access control.

According to a feature of the invention, the access information comprises a restricted access playback sequence indication comprising a first protected section and an unrestricted access playback sequence indication not comprising the first protected section, and the means for generating a presentation signal is operable to generate the presentation signal from the restricted access playback sequence indication if the access permission level corresponds to an unlimited access permission level and for generating the presentation signal for the content item in response to the unrestricted access playback sequence indication if the access permission level corresponds to a limited access permission level. This enables low complexity playback of different versions of a content item in response to access levels determined by a user (e.g. a parent) in response to an access code entry of a viewer (e.g. a child). Hence, a very flexible and low complexity access control is provided, which enables access control to a content item to be customised to the individual user.

According to a third aspect of the invention, there is provided a method of recording a content item on a recordable medium, the method comprising the steps of: receiving a content item for recording; receiving protection information from an end user; dividing the content item into a plurality of sections in response to the protection information; determining an access characteristic for each of the plurality of sections in response to the protection information; storing the content item and access information comprising the access characteristic for each of the plurality of sections on a recordable medium. A method of recording a content item on a recordable medium is thus provided allowing low complexity, flexible and/or customisable access control.

According to a feature of the invention, the method further comprises the steps of: determining at least a first protected section of the plurality of sections in response to the protection information; generating a restricted access playback sequence indication comprising the first protected section; generating an unrestricted access playback sequence indication not comprising the first protected section; and including the restricted access and unrestricted access playback sequence in the access information. This allows for the different versions of the content item being determined and generated during the recording phase. Additionally or alternatively, the feature allows for a very simple and low complexity playback of the different versions of the content item on the recordable medium.

According to another feature of the invention, the method further comprises the steps of: receiving an access input from a playback user; setting an access permission level in response to the access input; retrieving the content item and the access information from the recordable medium; and generating a presentation signal for the content item in response to the access permission level and the access information. This allows for a low complexity and highly flexible access control when playing back a content item on the recordable medium.

These and other aspects, features and advantages of the invention will be apparent from and elucidated with reference to the embodiment(s) described hereinafter.

An embodiment of the invention will be described, by way of example only, with reference to the drawings, in which

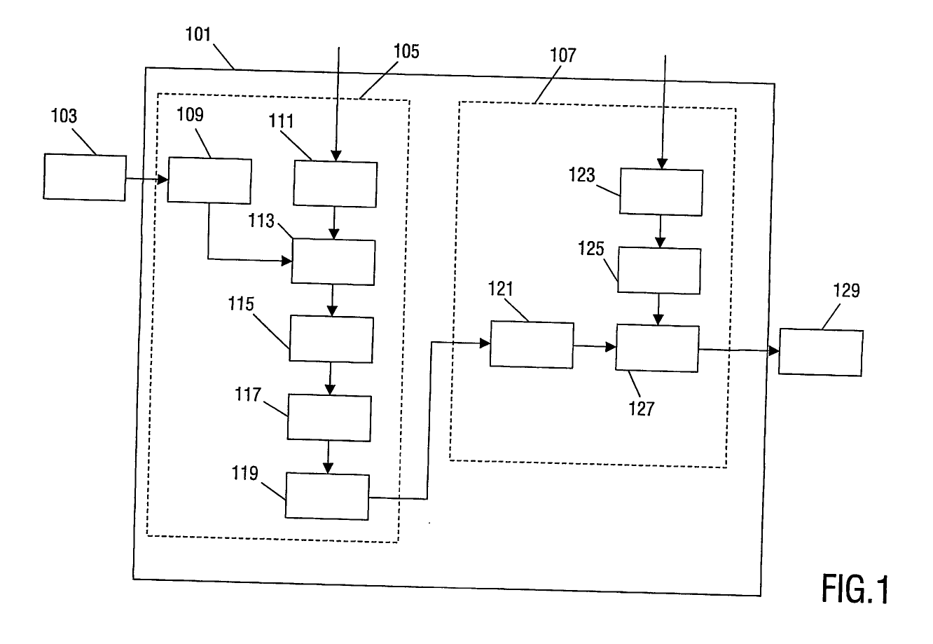

FIG. 1 is an illustration of a block diagram of a content item recorder in accordance with an embodiment of the invention;

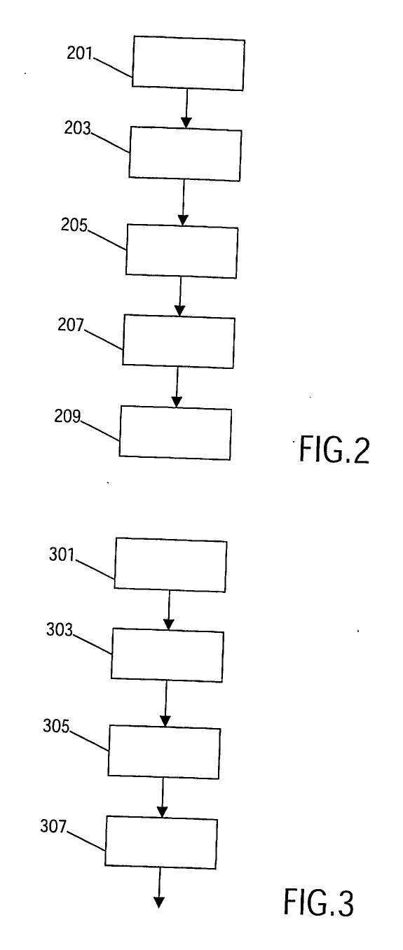

FIG. 2 illustrates a flow chart of a method of recording a content item on a recordable medium in accordance with an embodiment of the invention; and

FIG. 3 illustrates a flow chart of a method of playing back a content item on a recordable medium in accordance with an embodiment of the invention.

The following description focuses on an embodiment of the invention for the specific application of providing parental access control functionality for a DVD recorder. However, it will be appreciated that the invention is not limited to this application. For example, the invention may be applied to other forms of access control and other content item recorders including for example Personal Video Recorders (PVRs). In the described embodiment, the content item recorder is operable to record audiovisual content items comprising both audio and video.

FIG. 1 is an illustration of a block diagram of a content item recorder 101 in accordance with an embodiment of the invention.

The content item recorder 101 is coupled to an external video source 103 from which one or more audiovisual content items are received. In the described embodiment, the external source may for example be a receiver for receiving a TV signal distributed by radio broadcast. The video source 103 may thus provide content items in the form of TV programmes. In other embodiments, the external video source may for example be a digital video camera. In the preferred embodiment, the content item recorder 101 is operable to be coupled to a plurality of different video sources of different types.

The content item recorder 101 in accordance with the preferred embodiment comprises a content item recording part 105 and a content item playback part 107. The content item recording part 105 comprises an interface 109 which is coupled to the external video source 103 and is operable to receive a content item for recording from the external video source 103. The interface 109 may comprise a plurality of different inputs for different formats. For example, the interface 109 may comprise an analogue input for receiving analogue AV signals from analogue sources, and a digital input for receiving digital AV signals from digital video sources.

The content item recording part 105 further comprises user input means 111 for receiving protection information from an end user of the content item recorder 101. In the preferred embodiment, the protection information relates to a level of protection desired by the end user of at least one section of the content item. Specifically, the user may define an access level requirement for at least one section of the content item. Preferably, the user may provide protection information by selecting one or more sections of the content item which are to be protected and have restricted access.

The interface 109 and the user input means 111 are coupled to a section processor 113 which is operable to divide the content item into a plurality of sections in response to the protection information. In the preferred embodiment, the section processor 113 simply divides the content item into a first group comprising the sections identified by the user as protected sections and a second group comprising the sections not identified as protected sections.

The section processor 113 is coupled to an access characteristics processor 115 which is operable to determine an access characteristic for each of the plurality of sections in response to the protection information. In a simple embodiment, the access characteristic of each section of the content item simply corresponds to an indication of whether the end user (e.g. a parent) has categorised the section as protected or unprotected.

The access characteristics processor 115 is coupled to a recording processor 117 which is operable to store the content item and access information, comprising the access characteristic for each of the plurality of sections, on a recordable medium 119, which in the described embodiment is a recordable DVD. In some embodiments, the recording processor 117 may record the access characteristics associated with each section. For example, for each section a data value is recorded indicating if the particular section has been characterised as protected or unprotected by the user.

However, in the preferred embodiment, the access information comprises a plurality of playback sequence indications such as playlists. For example, a restricted access playback sequence indication may be generated as a playlist which comprises all sections of the content item arranged sequentially. Hence, this playlist prescribes the playback of the entire content item including both protected and unprotected sections. This will correspond to a restricted, e.g. adults only, playlist for the content item. In addition, an unrestricted access playback sequence indication is generated as a playlist comprising only the sections of the content item which the end user has defined as not protected sections. This playlist thus corresponds to a presentation sequence of the content item which omits all the protected sections. The unrestricted access playback sequence indication may in this example correspond to a version of the content item suitable for children.

The content item and access information is stored on the recordable medium 119 in any suitable format. Preferably the format is in accordance with a common standard for a recordable DVD.

The content item playback part 107 comprises a retrieve processor 121 which is coupled to the recordable medium and is operable to retrieve the content item and the access information from the recordable medium. It will be appreciated that in many embodiments, the recording processor 117 and the retrieve processor 121 share common interface circuitry for interfacing with the recordable medium. For example, in the preferred embodiment of a DVD recorder, a laser disc drive is shared between the functional blocks.

The content item playback part 107 further comprises a second user input means 123, which is operable to receive an access input from a playback user. The user may for example be a child intending to playback the content item from the recordable medium. The access input is in the preferred embodiment an access code. In the preferred embodiment, the first and second user input means are shared and thus a single means for receiving user inputs is used for both the content item recording part 105 and the content item playback part 107.

The second user input means 123 is coupled to an access level processor 125 which is operable to set an access permission level in response to the access input. In the preferred embodiment, the access level processor 125 simply sets an access permission level to an unlimited access level if an access code is received that corresponds to a previously stored access code. This code may preferably be set in advance by the end user, for example when recording the content item. If no matching access code has been received from the user, the access permission level is set to a limited access level.

The access level processor 125 and retrieve processor 121 are coupled to a presentation processor 127 which is operable to generate a presentation signal for the content item in response to the access permission level and the access information. In the preferred embodiment, the presentation processor 127 is operable to retrieve the unrestricted access playback sequence indication if the access permission level is set to limited access. Thus, if no or a non-matching access code has been provided to the content item playback part 107, a presentation signal is generated based on the playlist which has omitted all protected sections of the content item. Thus, specifically a version of the content item suitable for children is generated. In the preferred embodiment, the presentation processor 127 is furthermore operable to retrieve the restricted access playback sequence indication if the access permission level is set to unlimited access. Thus, if a matching access code has been provided to the content item playback part 107, a presentation signal is generated based on the playlist which comprises all sections of the content item including the protected sections. Specifically an adult only version of the content item may be generated.

The presentation processor 127 is coupled to an external presentation device 129. In the preferred embodiment, the external presentation device 129 is a video monitor or TV and the presentation signal is a signal suitable for a video monitor or TV.

Thus, a simple but highly flexible access control is provided by the described embodiment. For example, a parent may record content items, such as for example a film, and identify scenes that the parent considers unsuitable for their children. These scenes may be protected and both an adult only version and a child friendly version of the film may be created by the parent. During playback, the child friendly version of the film is shown unless a parental access code is entered, in which case the adult only version is shown. Thus a user, such as a parent, may create versions of a content item suitable for different categories of viewers. The user may flexibly create a version considered to be suitable for a specific user group. Hence, the different versions and access control may be customised to the specific preferences of a specific environment This, for example, allows each family to generate versions of a content item that they specifically consider to be suited for the members of the family. Specifically, parents may remove exactly those parts of a film that they consider unsuitable for the children of their family. Furthermore, it will be clear that a plurality of versions and access permission levels may be used. This may for example allow parents to create protected versions of the film, which suit each individual child of the family. Thus more scenes may be allowed to be presented for an older child than for a younger child.

FIG. 2 illustrates a flow chart of a method of recording a content item on a recordable medium in accordance with an embodiment of the invention. The method is applicable to the content item recorder of FIG. 1 and will be described with reference to this.

In step 201, the content item recorder 101 receives a content item for recording from an external video source 103. In the preferred embodiment, the content item is received from a content provider and specifically from a broadcast content provider. Typically, a content provider provides content to a plurality of users and typically some form of point to multi-point distribution of the content is used. For example, the external video source 103 may comprise a TV receiver that receives broadcast TV signals and converts them into a suitable format for the content item recorder 101. Thus, in a specific embodiment, the content item recorder 101 is used to record TV programmes.

Step 201 is followed by step 203 wherein protection information is received from a user. Any suitable system for receiving information from a user related to protection of aspects of the content item may be used. In the preferred embodiment, the user is provided with video editing functionality allowing him to view the content item, and is specifically provided with means for quickly accessing and viewing different instants of the content item. For example, the user may be provided with a time line corresponding to the content item from which a given instant can be accessed and viewed. In addition, the user is preferably provided with means for fast forwarding and reversing through the content item. The user may use this functionality to find and mark one or more sections of the content item, which are to be protected. For example, a start and end of a scene containing content considered to be unsuitable for children may be identified and marked by a user. In more complex embodiments, the user may mark several sections and for each section select a level of protection.

Step 203 is followed by step 205 wherein the section processor 113 divides the content item into a plurality of sections in response to the protection information. In the preferred embodiment, the content item is divided into the sections identified by the user as protected sections in step 201 and the sections not defined as protected sections by the user. In more complex embodiments, the content item is divided into different sections corresponding to each of the sections marked by the user and associated with a given level of protection.

Step 205 is followed by step 207 wherein the access characteristic processor 115 determines an access characteristic of each of the sections generated in step 203. In the preferred embodiment, the access characteristic is simply set to protected or unprotected according to whether the user has marked the section as protected or not. Hence, in this embodiment the content item is divided into a plurality of sections which are either unprotected (and thus in the specific example considered suitable for children) or protected (and thus in the specific example considered unsuitable for children). In more complex embodiments, more levels of protection may be provided thus allowing for a finer granularity of the access control. For example, a protection level corresponding to each member of a family may be provided allowing a content item version suitable for each individual member of the family to be generated by the user when recording the content item.

In the preferred embodiment, playback sequences, such as playlists, are generated corresponding to different versions of the content item. In the preferred embodiment, a restricted playback sequence indication comprising the entire content item is generated. In addition, an unrestricted playback sequence indication is created wherein all the protected sections are omitted. In accordance with this unrestricted playback sequence, a protected section is skipped, and thus one unprotected section is directly followed by the next unprotected section. For example, in an embodiment wherein each section corresponds to a scene, the protected scenes are omitted from the unrestricted playback sequence, which accordingly creates a content item comprising only the unprotected scenes that are considered suitable for children. In more complex embodiments, more levels of protection may be used and accordingly a higher number of restricted playback sequences may be generated corresponding to the different protection levels. For example, a playback sequence may be generated for each member of the family.

Step 207 is followed by step 209 wherein the content item is stored on the recordable medium by the recording processor 117. In addition, the recording processor 117 generates access information comprising access characteristics for each of the sections of the content item. In the preferred embodiment, the access characteristics are represented in the access information by the playback sequence indications. Thus the access characteristic of a protected section is indicated by the section being included in the restricted playback sequence indication but not the unrestricted playback sequence. Specifically, the access information may comprise only the playback sequence indications. The recording processor 117 records the access information on the recordable medium for use during playback.

However, in other embodiments the access information may comprise data related to the division of the content item into different sections together with a specific access characteristic for each section. For example, a data value may be stored for each section corresponding to a protection level given to that section by the user.

FIG. 3 illustrates a flow chart of a method of playing back a content item on a recordable medium in accordance with an embodiment of the invention. The method is applicable to the content item recorder of FIG. 1 and will be described with reference to this.

In step 301 the second user input means 123 receives an access input from a playback user. Specifically, a user may be asked for an access code and may in response enter an access code. In some embodiments, the access input may comprise a lack of an access input or code being input. Thus the access input may specifically be that no access code has been received.

Step 301 is followed by step 303 wherein an access permission level is set in response to the access input by the access level processor 125. Specifically, the access level processor 125 may detect if an access code has been received which matches an access code that has been stored in the recorder or alternatively or additionally on the recordable medium. In the preferred embodiment, the access level processor 125 sets an access permission level to unlimited access if a matching access code has been received, and if no access code or a wrong access code has been received, the access permission level is set to limited access.

Thus, a parent may store a parental access code, which must be entered in order to have an unlimited access permission level. However, children not having the parental access code may still use the content item recorder for playback but will only have a limited access permission level.

Step 303 is followed by step 305 wherein the retrieve processor 121 retrieves the access information from the recordable medium. In the preferred embodiment, the access information comprises an unrestricted access playback sequence indication and a restricted access playback sequence indication. If the access permission level is set to limited access the unrestricted access playback sequence is retrieved (or selected if both are retrieved from the recordable medium). The retrieve processor 121 then proceeds to retrieve the content item from the recordable medium 119 in response to the unrestricted access playback sequence. Hence, a version of the content item is retrieved which does not contain any of the protected sections. Thus a version suitable for children may be retrieved if none or the wrong access code has been entered.

If the access permission level is set to unlimited access, the restricted access playback sequence is retrieved (or selected if both are retrieved from the recordable medium). The retrieve processor 121 then proceeds to retrieve the content item from the recordable medium 119 in response to the restricted access playback sequence. Hence, a version of the content item is retrieved that contains all the protected sections. Thus an adult only version is retrieved if the correct access code has been entered.

Step 305 is followed by step 307 wherein the presentation processor 127 generates a suitable presentation signal based on the retrieved content item.

In some embodiments, a larger number of playback sequences are comprised in the access information and a suitable sequence is selected in response to the access level.

In some embodiments, for example where an access characteristic data value is stored individually for each section of the content item, the retrieve processor 121 retrieves the access characteristics data value for a given section and evaluates if this is considered allowable for the given access permission level. If so, the section is included in the presentation signal and otherwise the retrieve processor 121 proceeds to retrieve the access characteristics data value for the next section to evaluate if this should be included. In this embodiment, the playlist is thus generated at playback from the access characteristics of each section stored on the recordable medium.

In the preferred embodiment, a plurality of content items may be stored on a single recordable medium. In this case, access protection may be provided on one, more or all of the content items. Preferably, a protection indication is stored on the recordable content medium for each content item. Thus, each unprotected content item may be accessed by all users without inputting any access code. However, protected items may be accessed in different versions depending on the access permission level as previously described. Hence, a recordable medium such as a recordable DVD, may be provided with a hierarchical access control that allows individual content items to be individually controlled, and furthermore allows each of the protected content items to have different access control levels and therefore to be presented in different versions to users depending on the access permission levels.

The described embodiment provides a very flexible and customisable access control for a recordable medium. For example, parental control may be provided for recordable DVDs. A user of the content item may make a playlist (a parental cut) and protect it by an access code. An edited version (a general cut) will be provided at playback unless a suitable access code has been entered. In accordance with the embodiment, only the title parts of the DVD need to be protected and not necessarily the whole DVD. Thus, the inconvenience of access control is minimised and access control does not require or result in recorder lock or even disc lock. Rather, access to suitable material is still enabled. Furthermore, the embodiment allows for the access control to be customised in order to meet the specific requirements and preferences of an individual user or group of users (e.g. a specific family).

It will be apparent to a person skilled in the art that the invention can be applied to pre-recorded disks (or other media) as well. To this end, scenes may be classified and the classification is stored on a separate medium, for example a flash memory.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A content item recorder (101) comprising:
means (109) for receiving a content item for recording;
a user input (111) for receiving protection information from an end user;
means (113) for dividing the content item into a plurality of sections in response to the protection information;
means (115) for determining an access characteristic for each of the plurality of sections in response to the protection information;
means (117) for storing the content item and access information comprising the access characteristic for each of the plurality of sections on a recordable medium (119).

2. A content item recorder (101) as claimed in claim 1 wherein the means (115) for determining an access characteristic further comprises:
means for determining at least a first protected section of the plurality of sections in response to the protection information;
means for generating a restricted access playback sequence indication comprising the first protected section;
means for generating an unrestricted access playback sequence indication not comprising the first protected section; and
means for including the restricted access and unrestricted access playback sequences in the access information.

3. A content item recorder (101) as claimed in claim 2 wherein the restricted access playback sequence indication or the unrestricted access playback sequence indication comprises an ordered playback sequence of at least some of the plurality of sections.

4. A content item recorder (101) as claimed in claim 2 wherein the restricted access playback sequence indication comprises an ordered playback sequence of the plurality of sections and the unrestricted access playback sequence indication comprises an ordered playback sequence of a subset of the plurality of sections.

5. A content item recorder (101) as claimed in claim 4 further comprising playback means (107) for generating a presentation signal from the content item stored on the recordable medium (119), the playback means (107) comprising means (123) for receiving an access input from a playback user;
means (125) for setting an access permission level in response to the access input;
means (121) for retrieving the content item and the access information from the recordable medium (119); and
means (127) for generating a presentation signal for-the content item in response to the access permission level and the access information.

6. A content item recorder (101) as claimed in claim 5 wherein the means (127) for generating a presentation signal is operable to generate the presentation signal only from sections of the plurality of sections for which the access characteristic indicates that access is permitted for the access permission level.

7. A content item recorder (101) as claimed in claim 5 wherein the access information comprises a restricted access playback sequence indication comprising a first protected section and an unrestricted access playback sequence indication not comprising the first protected section, and the means (127) for generating a presentation signal is operable to generate the presentation signal from the restricted access playback sequence indication if the access permission level corresponds to a unlimited access permission level, and for generating the presentation signal for the content item in response to the unrestricted access playback sequence indication if the access permission level corresponds to limited access permission level.

8. A content item recorder (101) as claimed in claim 1 further wherein the means (117) for storing is operable to record a plurality of content items and a protection indication for each of the plurality of content items; wherein the protection indication for a content item indicates if the content item is protected.

9. A content item recorder (101) as claimed in claim 1 further comprising means for recording on the recordable medium an access code associated with the access information.

10. A content item recorder (101) as claimed in claim 1 further comprising means for receiving the content item from a content provider.

11. A content item recorder (101) as claimed in claim 11 wherein the content provider is a broadcast content provider.

12. A content item recorder (101) as claimed in claim 1 wherein the recordable medium is a recordable Digital Video Disc (DVD).

13. A content item recorder (101) as claimed in claim 1 wherein the recordable DVD is in accordance with the DVD +ReWritable video format specifications.

14. A content item recorder (101) as claimed in claim 1 wherein the content item is an audiovisual content item.

15. A content item player for generating a presentation signal from a recordable medium comprising a content item dividing into a plurality of sections and access information comprising an access characteristic for each of the plurality of sections; the playback means comprising
means (123) for receiving an access input from a playback user;
means (125) for setting an access permission level in response to the access input;
means (121) for retrieving the content item and the access information from the recordable medium (119); and
means (127) for generating a presentation signal for the content item in response to the access permission level and the access information.

16. A content item player as claimed in claim 15 wherein the access information comprises a restricted playback sequence indication comprising a first protected section and an unrestricted playback sequence indication not comprising the first protected section and the means for generating a presentation signal is operable to generate the presentation signal from the restricted playback sequence indication if the access permission level corresponds to an unlimited access permission level and for generating the presentation signal for the content item in response to the unrestricted playback sequence indication if the access permission level corresponds to a limited access permission level.

17. A method of recording a content item on a recordable medium, the method comprising the steps of:
receiving (201) a content item for recording;
receiving (203) protection information from an end user;
dividing (205) the content item into a plurality of sections in response to the protection information;
determining (207) an access characteristic for each of the plurality of sections in response to the protection information; storing (209) the content item and access information comprising the access characteristic for each of the plurality of sections on a recordable medium.

18. A method of recording a content item on a recordable medium as claimed in claim 17, further comprising the steps of:
determining at least a first protected section of the plurality of sections in response to the protection information; generating a restricted playback sequence indication comprising the first protected section;
generating an unrestricted playback sequence indication not comprising the first protected section; and
including the restricted and unrestricted playback sequence in the access information.

19. A method of recording a content item on a recordable medium as claimed in claim 17, further comprising the steps of:
receiving (301) an access input from a playback user;
setting (303) an access permission level in response to the access input;
retrieving (305) the content item and the access information from the recordable medium; and
generating (307) a presentation signal for the content item in response to the access permission level and the access information.

20. A computer program enabling the carrying out of a method according to claim 19.

21. (canceled)
